(19) United States
(12) Patent Application Publication
(10) Pub. No.: US 2002/0073406 A1
(43) Pub. Date: Jun. 13, 2002

(54) Using performance counter profiling to drive compiler optimization

(76) Inventor: Darryl Gove, Santa Clara, CA (US)

Correspondence Address: ROSENTHAL & OSHA L.L.P., 1221 MCKINNEY AVENUE, SUITE 2800, HOUSTON, TX, 77010, US

(21) Appl. No.: 09/737,097

(22) Filed: Dec. 12, 2000

(51) Int. Cl. G06F 9/45

(52) U.S. Cl. 717/154; 717/158; 717/127

(57) ABSTRACT

A method and apparatus that uses event counter information to improve the performance of a compiled application is disclosed. Compiler performance is improved by monitoring a first set of a plurality of event types, collecting data for the first set of the plurality of event types, rotating the monitoring to a second set of the plurality of event types, and collecting data for the second set of the plurality of event types. An event monitor for a plurality of event types and a data collector that collects data from the event monitor are included. The event monitor is selectively rotated from monitoring a first set of the plurality of event types to a second set of the plurality of event types and the data collector collects data for the first set and the second set of the plurality of event types.

### BACKGROUND OF THE INVENTION

A modern computer system comprises a microprocessor, memory, and peripheral computer resources, i.e., monitor, keyboard, software programs, etc. The microprocessor includes arithmetic, logic, and control circuitry that interpret and execute instructions from a computer program. FIG. 1 shows a prior art block diagram of a microprocessor (10) having, among other components, a central processing unit (“CPU”) (12), a memory controller (14), also known as a load/store unit, and on-board, or level 1, cache memory (16). The microprocessor (10) is also connected to external, or level 2, cache memory (17) and to the main memory (18) of the computer system.

One goal of the computer system is to execute instructions provided by the users of the computer and software programs. The execution of instructions is carried out by the CPU (12). Data needed by the CPU (12) to carry out an instruction are fetched by the memory controller (14) and loaded into internal registers (15) of the CPU (12). Upon command from the CPU (12), the memory controller searches for data first in the fast on-board cache memory (16), then in the slower external cache memory (17), and if those searches are unsuccessful, finally the memory controller retrieves the data from the slowest form of memory, main memory (18).

The time between a CPU request for data and when the data is retrieved and available for use by the CPU is referred to as the “latency” of the system. If requested data is found in cache memory, i.e., a data “hit” occurs, then the requested data can be accessed at the speed of the cache memory and the overall latency of the system is decreased. On the other hand, if requested data is not found in the cache memory, i.e., a data “miss” occurs, then the data must be retrieved from the relatively slow main memory, and the overall latency of the system is increased.

Because the CPU runs at significantly greater speeds than either cache memory or main memory, a significant portion of the CPU's time is spent waiting for data to be retrieved from one of the various forms of memory. In order to counter this performance inhibition, various techniques have been employed to increase computing performance and efficiency.

In order to produce machine understandable code from user code, a computer system typically comprises at least one compiler. Typically, a compiler is a piece of software that translates code from one form to another. One of the primary objectives of the compiler is to generate the fastest possible code with respect to execution performance. One method of improving the performance of code entails using profiling, i.e., running the application and then using the results of that run to aid the compiler in producing faster running code.

Other automated and manual techniques for improving compiler performance also exist. For instance, the use of flags is a mechanism for manually improving compiler performance. The flags are passed to the compiler to suggest a particular approach for compiling a program or application.

In the pursuit of improving implemented techniques and increasing performance, performance monitoring software is used to monitor events in a microprocessor. By monitoring microprocessor events, the performance of the different components of a processor and the efficiency and behavior of software programs can be analyzed. One way to use performance monitoring software is to implement, in hardware, counters that track the number of times a particular event occurs. Event counters monitor the various parts of the processor for particular events, and if an event of the type being monitored by a particular event counter occurs, that event counter is incremented. Particular events monitored may include, for example, the execution of a read from level 1 cache (16), an execution of a read that missed level 1 cache (16) but hit level 2 cache (17), or an execution of a read that missed both level 1 cache (16) and level 2 cache (17). By counting particular events, performance monitoring software can analyze the performance of hardware and/or programs based on how many times a specific event is actually occurring. Additionally, the performance monitoring software can compare the actual counts of events with simulated counts of the events. Using this information, a user can modify a software program or make changes to hardware in order to increase system performance and processor efficiency. Performance monitoring software, through the use of event counters, can decipher whether particular performance problems are occurring and how frequently certain events are occurring.

Referring to FIG. 2, a block diagram of a microprocessor (30) using event counters is shown. The microprocessor (30) is connected to memory (29) in a conventional manner. In order to track different events, such as those discussed above, the microprocessor (30) comprises multiple event counters (32, 34, 36, 38, 40). Each event counter, E1 . . . En (32, 34, 36, 38, 40), tracks a particular kind of event. The information accumulated by the event counters (32, 34, 36, 38, 40) is used by the compiler and other software applications (37) within the computer system.

Typically, there are more event types then there are event counters available to count the events. The reason for this is that the implementation of event counters within hardware necessitates the incorporation of additional circuitry that is not essential to the function of the microprocessor. Further, since processor hardware space is usually very limited, the addition of numerous event counters causes architectural and layout limitations in the design of the processor.

### SUMMARY OF THE INVENTION

In general, in one aspect, a method for improving compiler performance comprises monitoring a first set of a plurality of event types, collecting data for the first set of the plurality of event types, rotating the monitoring to a second set of the plurality of event types, and collecting data for the second set of the plurality of event types. In accordance with one or more embodiments, a plurality of event counters may be used to monitor the first set and the second set of the plurality of event types. A software tool may collect data from the first set and the second set of the plurality of event types. The method may further comprise determining whether the data collected for the first set of the plurality of event types is sufficient to allow flags to be applied to a section of a program. The flags may be selectively applied to the program through a compiler when the data collected is not sufficient to allow flags to be applied to particular sections of a program.

In general, in one aspect, an apparatus for improving compiler performance comprises an event monitor for a plurality of event types and a data collector that collects data from the event monitor. The event monitor is selectively rotated from monitoring a first set of the plurality of event types to a second set of the plurality of event types and the data collector collects data for the first set and the second set of the plurality of event types. In accordance with one or more embodiments, the event monitor may comprise a plurality of event counters. The apparatus may further comprise a software tool for collecting data from the event monitor. A flag may be selectively applied to a section of a program based on whether the data collected is sufficient to allow a flag to be applied to a particular section of the program. A flag may be selectively applied to the entire program when the data collected is not sufficient to allow one or more flags to be applied to particular sections of the program.

In general, in one aspect, an apparatus for improving compiler performance comprises means for monitoring a first set of a plurality of event types, means for collecting data, and means for rotating the monitoring to a second set of the plurality of event types. In accordance with one or more embodiments, the apparatus may further comprise means for determining whether the data collected from a set of the plurality of event types is sufficient to allow one or more flags to be selectively applied, via a compiler, to particular sections of a program. The apparatus may comprise means for selectively applying one or more flags, via the compiler, to the entire program when the data collected is not sufficient to allow flags to be applied to particular sections of the program.

Other aspects and advantages of the invention will be apparent from the following description and the appended claims.

### BRIEF DESCRIPTION OF THE DRAWINGS

FIG. 1 is a block diagram of a typical microprocessor.

FIG. 2 is a block diagram of a microprocessor that uses event counters.

FIG. 3a is a block diagram of a portion of a program shown in accordance with an embodiment of the present invention.

FIG. 3b is a block diagram of a portion of a program shown in accordance with an embodiment of the present invention.

FIG. 3c is a block diagram of a portion of a program shown in accordance with an embodiment of the present invention.

FIG. 4 shows a flow diagram of a process in accordance with an embodiment of the present invention.

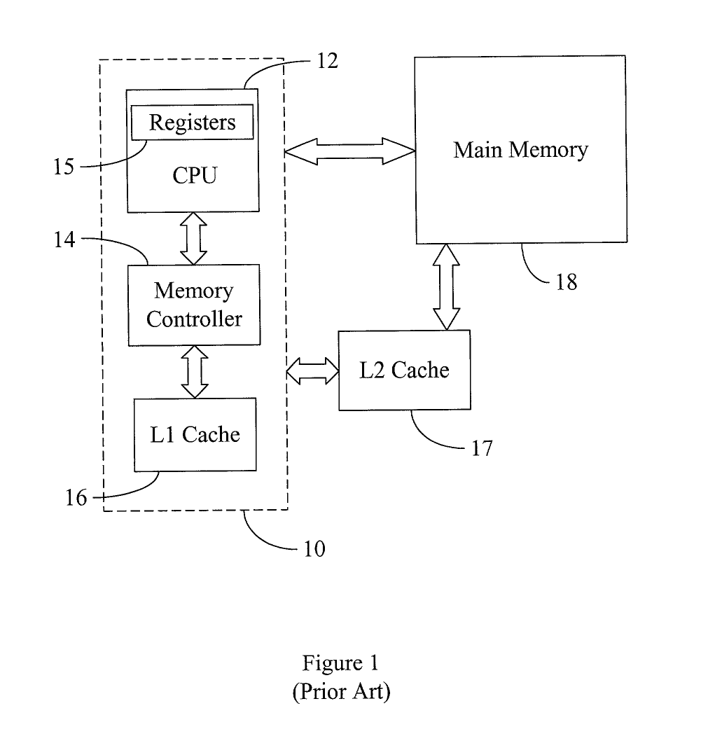

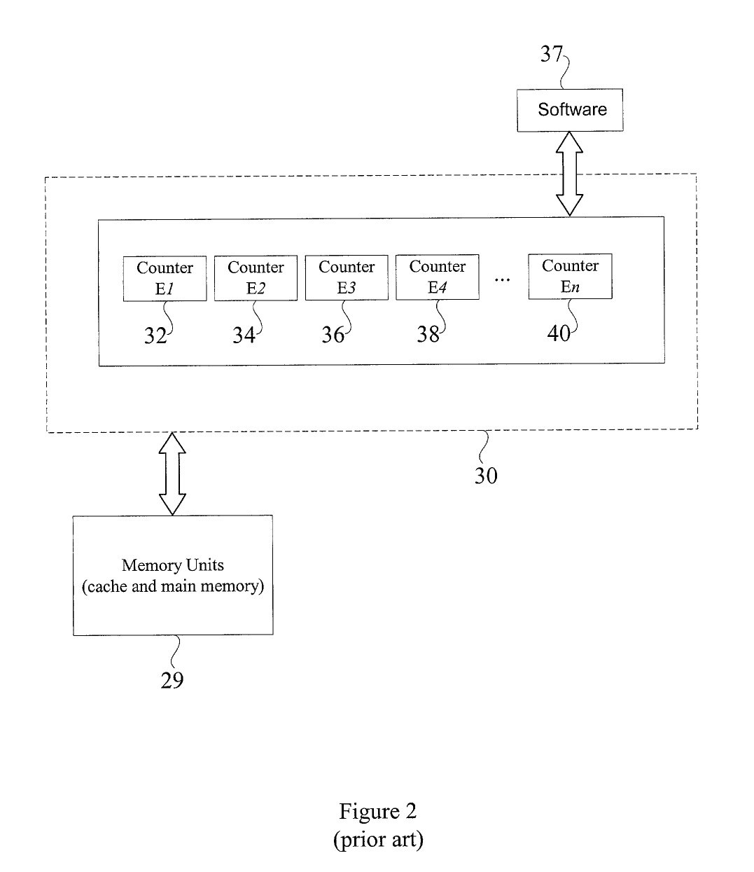

### DETAILED DESCRIPTION OF THE INVENTION

The present invention relates to a method and apparatus that uses event counter information to improve the performance of a compiled application. By collecting profiling and event counter information from the execution of the application, the compiler can produce faster code for subsequent applications and programs. Further, the present invention relates to a method for determining how particular flags should be used by the compiler with respect to the application being executed.

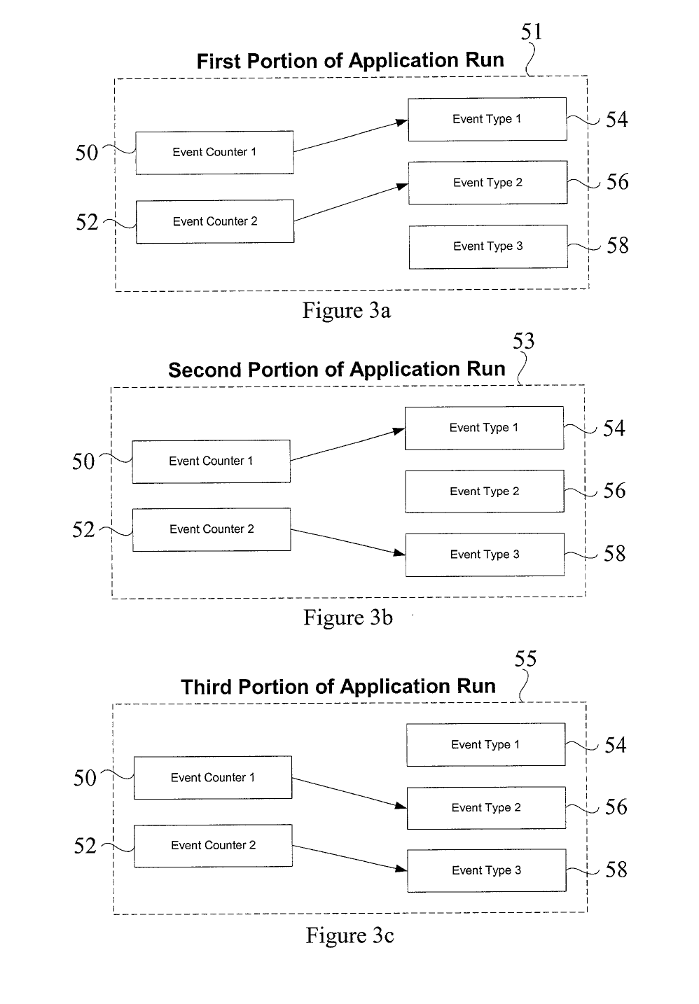

In order to track event types efficiently and accurately, event counters are rotated so that a representative sample of all the event types is collected. For instance, in an exemplary embodiment of the present invention shown in FIGS. 3a, 3b, and 3c, there are three different types of events (54, 56, 58) and two event counters (50, 52). To handle this inequality, the performance monitoring for an application run is divided into three portions.

For the first portion of the application run (51), Event Counter 1 (50) monitors for occurrences of Event Type 1 (54) and Event Counter 2 (52) monitors for occurrences of Event Type 2 (56). In the next portion of the application run (53), Event Counter 1 (50) monitors for occurrences of Event Type 1 (54) and Event Counter 2 (52) monitors for occurrences of Event Type 3 (58). For the final portion of the application run, Event Counter 1 (50) monitors Event Type 2 (56) and Event Counter 2 (52) monitors Event Type 3 (58). By rotating the event counters (50, 52) to monitor a different set of events at designated periods, although, there are fewer event counters (50, 52) than event types (54, 56, 58), the compiler can still collect a representative sample of all event types (54, 56, 58). Those skilled in the art will appreciate that in other embodiments, there may be different amounts of event types and event counters. Also, in other embodiments, the event counters may rotate at different intervals during the execution of an application.

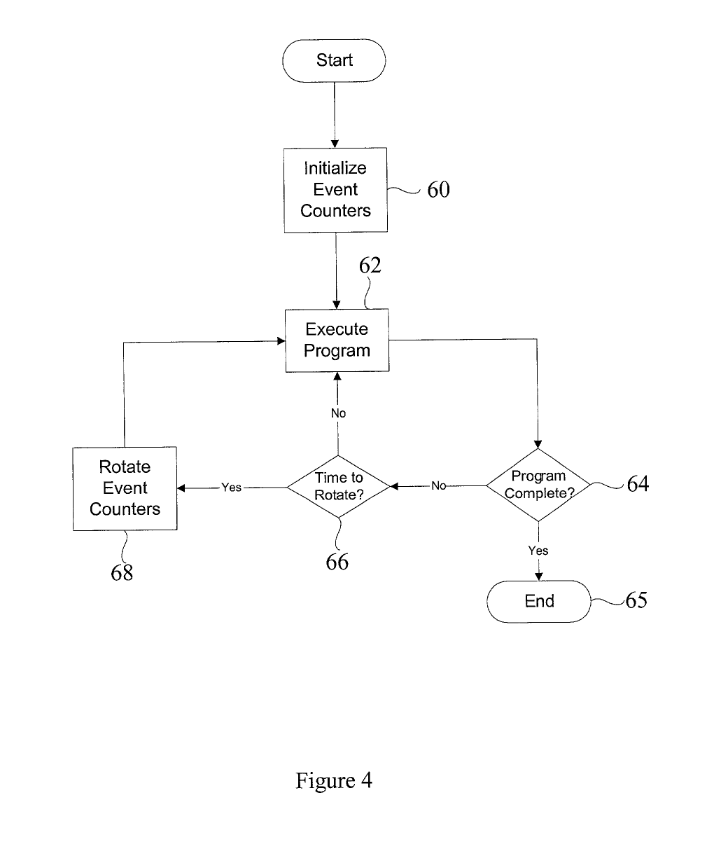

Referring to FIG. 4, a flow diagram of a process in accordance with an embodiment of the present invention is shown. Before a program is executed, multiple event counters are initialized (step 60) either by software or hardware to ensure that event counts during the execution of the program are accurate. Once the event counters are initialized (step 60), a microprocessor executes one executable part, e.g., one instruction, of the program (step 62).

In the embodiment shown in FIG. 4, the flow process represents one cycle, and therefore, in order to completely execute a program, the processor must repeatedly cycle through the flow process. When the processor finishes processing the executable part (step 62), the processor checks to see if the program is complete (step 64), i.e., whether there are any remaining executable parts in the program. If there are no remaining executions to be performed for the program, then the processor is finished and the flow process ends (step 65). However, in the case that there are more executable parts remaining in the program, the processor, either via software or hardware, checks whether the event counters should be rotated to monitor a different set of events, i.e., the specified time period has ended (step 66). If the event counters do not need to be rotated in that given cycle, the processor executes the next executable portion of the program (step 62). On the other hand, if specified time period has ended, the event counters are rotated (step 68), and then the processor resumes executing parts of the program (step 62).

Typically, event counter information is used to relate particular events back to particular sections of code. In one exemplary embodiment, the present invention deals with improving compiler performance when there is a small amount of data with respect to the amount of accumulated event counter information. Although, the amount of data is sufficient to have some confidence that the data is representative of an entire run of an application, the amount of data is not sufficient to allow for allocation of particular events to particular sections of code. For instance, if a program is suffering from a large number of data cache misses, this indicates that it might be useful to compile with pre-fetch enabled, i.e., fetching instructions from memory before the instructions are actually used. Therefore, in subsequent compilations of the program, a flag is passed to the compiler to indicate to the compiler that it should enable pre-fetch operations to reduce data cache misses. Those skilled in the art will appreciate that in other embodiments, a flag that indicates a different mechanism may be passed to the compiler dependent upon program performance.

In one embodiment, a different mechanism may be used to improve compiler performance. For example, one or more event counters can be designated to monitor when pre-fetches are emitted, but not used because requested data is already in a particular cache unit. In this case, a flag can be passed to the compiler that instructs the compiler to deactivate pre-fetch operations. It follows that unnecessary pre-fetch operations can be eliminated, and accordingly, compiler performance increases.

In one exemplary embodiment, the preset invention involves handling situations when there is a sufficient amount of data available so that events can be mapped to particular sections of code. In most cases, there will be sufficient data collected for the compiler to attribute general optimization flags to the whole program. There will only be insufficient data for this if the run of the program is too short. In most of the cases where it is possible to attribute general optimization flags to the whole program, there will also be sufficient information to do this at the level of individual routines of code (this represents a finer grained level of detail). In particular, this is true when the program is run for a long period of time, or when most of the runtime of the program is consumed by only a few routines. There will be some cases where the amount of data collected is sufficient for whole-program level optimizations, but the runtime of the program did not allow for sufficient data to be collected to do the finer grained analysis. The compiler determines which particular sections of code are suffering from performance problems, e.g., cache misses, and thereafter, internally applies a flag to those particular sections of code. For instance, if a particular loop is having problems with data cache misses, the compiler can relate event counter information to the section of the code containing the particular loop, and then apply a flag that enables pre-fetch for that particular section of code. Thus, for loops that are executed entirely from data cache, a flag would not be applied by the compiler for the section of code containing these loops.

Advantages of the present invention may include one or more of the following. A compiler is allowed to increase its performance using event counter information. The event counter information not only serves as a profiling tool, but also allows the compiler to apply flags to particular sections of code, or the entire code, in order to increase performance. A compiler is allowed to increase its performance even when there are less event counters than event types.

Because additional event counters are not required to be implemented in the hardware, the amount of hardware redesign is reduced while compiler performance is increased. A compiler can increase its performance when there is a relatively small amount of data from the event counters. Therefore, in cases where the event counter information is not sufficient to allow flags to be applied to particular sections of code, the compiler can still increase its performance by applying flags to larger sections of code.

While the invention has been described with respect to a limited number of embodiments, those skilled in the art will appreciate that other embodiments can be devised which do not depart from the scope of the invention as disclosed herein. For example, in the presented embodiments, a method using event counters is described. The present invention is equally applicable to situations involving any event monitor. Likewise, while the above exemplary embodiments refer to a software tool such as a compiler collecting data, any data collector can be used. Accordingly, the scope of the invention should be limited only by the attached claims.

What is claimed is:

1. A method for improving compiler performance, comprising:
monitoring a first set of a plurality of event types;
collecting data for the first set of the plurality of event types;
rotating the monitoring to a second set of the plurality of event types; and
collecting data for the second set of the plurality of event types.

2. The method of claim 1, further comprising:
using a plurality of event counters to monitor the first set and second set of the plurality of event types.

3. The method of claim 2, wherein the plurality of event counters is less than the plurality of event types.

4. The method of claim 1, further comprising:
using a software tool to collect the data for the first set and the second set of the plurality of event types.

5. The method of claim 1, further comprising:
determining whether the data collected for the first set of the plurality of event types is sufficient to allow flags to be applied to a section of a program; and
selectively applying flags to the section of the program when the data collected is sufficient.

6. The method of claim 5, further comprising:
selectively applying flags to the program through a compiler when the data collected is not sufficient to allow flags to be applied to the section of the program.

7. The method of claim 1, wherein the plurality of event types comprise cache misses.

8. The method of claim 2, wherein the event counters are implemented in hardware.

9. The method of claim 1, further comprising:
rotating the monitoring to a third set of the plurality of event types.

10. An apparatus for improving compiler performance, comprising:
an event monitor for a plurality of event types; and
a data collector of data from the event monitor,
wherein the event monitor is rotated from monitoring a first set of the plurality of event types to a second set of the plurality of event types and
the data collector collects data for the first set and the second set of the plurality of event types.

11. The apparatus of claim 10, the event monitor comprising:
a plurality of event counters.

12. The apparatus of claim 11, wherein the plurality of event counters is less than the plurality of event types.

13. The apparatus of claim 10, further comprising:
a software tool for collecting data from the event monitor.

14. The apparatus of claim 10, further comprising:
a flag selectively applied to a section of a program based on whether the data collected is sufficient.

15. The apparatus of claim 10, wherein the plurality of event types comprise cache misses.

16. The apparatus of claim 10, wherein the event counters are implemented in hardware.

17. The apparatus of claim 10, wherein the event monitor is rotated to a third set of the plurality of event types and the data collector collects data for the third set of the plurality of event types.

18. A apparatus for improving compiler performance, comprising:
means for monitoring a first set of a plurality of event types;
means for collecting data for the first set of the plurality of event types;
means for rotating the monitoring to a second set of the plurality of event types; and
means for collecting data for the second set of the plurality of event types.

19. The apparatus of claim 18, further comprising:
means for determining whether the data collected for the first set of the plurality of event types is sufficient to allow flags to be applied to a section of a program; and
means for selectively applying flags to the section of the program when the data collected is sufficient.

20. The apparatus of claim 19, further comprising:
means for selectively applying flags to the program through a compiler when the data collected is not sufficient to allow flags to be applied to the section of the program.

21. The apparatus of claim 18, further comprising:
means for rotating the monitoring to a third set of the plurality of event types.
